(19) United States
(12) Patent Application Publication
(10) Pub. No.: US 2008/0153706 A1
(43) Pub. Date: Jun. 26, 2008

(54) Water-In-Oil Suspoemulsions

(75) Inventors: Gerhard Frisch, Wehrheim (DE); Ulrike Ebersold, Hattersheim (DE)

Correspondence Address: Womble Carlyle Sandridge & Rice, PLLC;Attn: Patent Docketing 32nd Floor, P.O. Box 7037, Atlanta, GA, 30357-0037, US

(73) Assignee: Bayer CropScience AG, Monheim (DE)

(21) Appl. No.: 11/911,803

(22) PCT Filed: Apr. 4, 2006
(86) PCT No.: PCT/EP06/03044

§ 371 Date: Oct. 17, 2007

(30) Foreign Application Priority Data
Apr. 26, 2005 (EP) 05009156.0

(51) Int. Cl. A01N 43/56; A01N 25/30; A01P 13/00

(52) U.S. Cl. 504/280; 504/358

(57) ABSTRACT

Novel ready-to-use formulations for active substance combinations (water-in-oil suspensions), comprising a water phase and a novel oil phase, comprising active substances, surfactants, organic carrier media, thickeners and, if appropriate, customary adjuvants and additives, which can be employed in the sectors agriculture/agrochemistry and veterinary medicine.

The invention relates to novel water-in-oil (W/O) suspoemulsions consisting of a water phase in conjunction with a specific oil phase. In addition, the invention also relates to the novel composition of the specific oil phase as such.

Various types of suspoemulsions are described for example in EP-A-01 17999, U.S. Pat. No. 4,824,663, EP-A-0289356, EP-A-0261492, EP-A-0143099 and U.S. Pat. No. 5,518,991. An overview of the suspoemulsions can be found in Pestic. Sci. 1990, 29, 451-465 (Recent Development in Suspoemulsions, P. Mulqueen et al.) and in Pestic. Sci. 1990, 29, 437-449 (Trends in the Formulation of Pesticides—An Overview, D. Seaman).

EP-A-139 4225 describes W/O thickener dispersions. They take the form of liquid and pourable preparations of a water-in-oil thickener suspension which comprises at least one thickener based on a synthetic or natural polyelectrolyte and, in addition, a natural oil such as rapeseed oil and one or more emulsifiers and dispersants which are based on sorbitan esters, alkyl polyglycosides, ethoxylated fatty alcohols and water.

Also known are W/O emulsions as described in EP 0244 754 B 1 or else in EP 1020 175 B 1. The first one takes the form of W/O emulsions or microemulsions in which a salt-like active substance such as, for example, glufosinate, is dissolved in water and a further active substance such as, for example, metolaclor is dissolved in the oil phase (organic phase). The second one takes the form of a water-in-oil-in-water (W/O/W) emulsion using a silicone fluid as the oil phase (organic phase) and an elastomeric silicone polyether as emulsifier for dispersing the water phase (aqueous phase).

In general, active substances are not employed as pure substances but, depending on the field of application and the desired physical composition of the use form in combination with certain adjuvants, i.e. they are “formulated”. Frequently, such formulations comprise combinations of different active substances instead of individual active substances in order to jointly exploit the properties of the individual active substances upon application, or else because the individual active substances in the combination are synergistic, i.e. result in superadditive gains in activity. In addition, it is an aim to achieve as high an active substance concentration (“loading density”) of the formulation in question since a high concentration of the active substances makes it possible to reduce the volumes to be applied and, as a consequence, entails material savings regarding the adjuvants which are co-applied and savings in the packaging and logistic sectors. In addition to a high active substance concentration, a sufficiently high storage stability of a formulation is also of great importance.

Highly concentrated, stable formulations and co-formulations together with environmentally friendly auxiliaries are therefore of fundamental interest. In addition, ready-to-use formulations are not only clearer, but also have advantages over methods in which the individual active substances are mixed together shortly before application (known as tank-mix methods). Examples which may be mentioned here are a guarantee that picking the wrong individual active substances is avoided and/or that unduly high or low dosages of the individual substances are ruled out from the outset.

The object of the present invention was to provide ready-to-use formulations which have advantageous properties, preferably those ready-to-use formulations which comprise two or more active substances.

Surprisingly, it has been found that the abovementioned objects can be achieved advantageously by the W/O suspoemulsions according to the invention.

The present invention relates to a water-in-oil suspoemulsion comprising

(a) a water phase

and

(b) an oil phase comprising the components
(b1) one or more agrochemical active substances,
(b2) one or more surfactants from the group of the alkoxylated tristyryl phenols, calcium dodecylbenzenesulfonate and the alkoxylated C₁-C₂₂-alcohols, linear and/or branched,
(b3) one or more organic carrier media,
(b4) one or more thickeners from the group of the modified natural silicates and synthetic silicates, and on the basis of synthetic polymers, natural polymers and natural oils,
(b5) and, if appropriate, customary adjuvants and additives.

In addition to water, the water phase (a) preferably comprises the components
(a1) one or more ionic surfactants from the group consisting of the polycarboxylates, N-alkyl-taurides, preferably N-(C₁-C₁₂)-tauride, especially preferably N-methyl-tauride, and lignosulfonates and also calcium dodecylbenzenesulfonates,
(a2) one or more salts,
(a3) if appropriate, one or more agrochemical active substances,
(a4) if appropriate, further surfactants which differ from component (a1),
(a5) and, if appropriate, customary adjuvants and additives.

In a preferred embodiment, the water-in-oil suspoemulsion comprises at least two active substances, at least one of which is present in dispersed form. In this context, one of the active substances is dispersed in the oil phase (b), while the other active substances are dispersed and/or dissolved in the oil phase (b) and/or the water phase (a).

The invention relates both to the W/O suspoemulsion and to its specific oil phase (b). The W/O suspoemulsion according to the invention may comprise either the two phases (a) and (b) together, or else it comprises only the oil phase (b) according to the invention, it being possible for the water phase (a) to correspond to the prior art.

The term “ready-to-use formulation” which is used hereinbelow is understood as meaning both the water-in-oil suspoemulsion according to the invention, comprising a water phase (a) and the oil phase (b) according to the invention, and the oil phase (b) according to the invention per se.

component (al) for the water phase (a), it is possible to select one or more ionic surfactants and/or to combine them with representatives from the group of the polycarboxylates, such as the Geropon® series from Rhodia, N-alkyl-taurides, preferably N-(C₁-C₁₂)-taurides, especially preferably N-methyl-taurides, such as Hostapon® T from Clariant, or lignosulfonates, such as Vanisperse CB® from Borrgaard or Reax® 85 from Westvaco, and also calcium dodecylbenzenesulfonates (see component (b2)).

As component (a2), it is possible to select salts such as alkali metal and ammonium carbonates, sulfates, nitrates, halides, hydrogencarbonates and phosphates, for example dipotassium hydrogenphosphate (K₂HPO₄) and the like.

The water phase (a) of the W/O suspoemulsions according to the invention may comprise additional active substances (a3), for example active substances which are soluble and/or insoluble in water, surfactants (a4) and customary adjuvants and additives (a5) (synonymous for auxiliaries) such as antifreeze agents, colorants, antifoams, fertilizers and the like.

The following may be formulated as component (b1) and/or (a3): agrochemical active substances, the term “agrochemical active substances” comprising all the substances which are employed in the sectors agriculture, horticulture, forestry and veterinary medicine and in the domestic sector and store keeping. These agrochemical active substances in the W/O suspoemulsion according to the invention include, for example, herbicides, insecticides, acaricides, rodenticides, fungicides, bactericides, nematicides, algicides, molluscicides, virucides, safeners, resistance-inducing active substances, active substances which act as repellents or as growth regulators, active substances comprising, and made from, biological organisms, and fertilizers which provide nutrients and trace elements. Especially preferred are substances which act as herbicides, insecticides, acaricides, fungicides, bactericides, virucides, growth regulators or as safeners, very especially preferred are herbicides, insecticides, fungicides and safeners, and preferred amongst these are herbicidal active substances. These preferred herbicides include, for example, herbicides with foliar activity such as ALS inhibitors (for example sulfonamides such as flucarbazone, propoxycarbazone or amicarbazone or sulfonylureas such as mesosulfuron, iodosulfuron, amidosulfuron, foramsulfuron), diflufenican, bromoxynil-containing or ioxynil-containing products, herbicides from the class of the oxyacetamides such as flufenacet, herbicides from the class of the aryloxyphenoxypropionates such as fenoxaprop-p-ethyl, beet herbicides such as desmedipham, phenmedipham, ethofumesate or metamitron, or else active substances from the class of the HPPD inhibitors (for example isoxaflutole, sulcotrione, mesotrione).

If the active substances comprise one or more asymmetric carbon atoms or else double bonds which are not mentioned specifically, the scope still extends to all isomers. The stereoisomers which are possible and which are defined by their specific spatial shape, such as enantiomers, diastereomers, Z and E isomers, all come under the scope and can be obtained by customary methods from mixtures of the stereoisomers or else be prepared by stereoselective reactions in combination with the use of stereochemically pure starting materials. Thus, not only the abovementioned stereoisomers in pure form, but also their mixtures, can be employed in accordance with the invention.

For the purposes of the present invention, active substances present in component (b1) and/or in (a3) are understood as meaning not only the neutral compounds, but also always their salts with inorganic and/or organic counterions. Thus, for example, sulfonylureas can form for example salts in which the hydrogen of the —SO₂—NH group is replaced by an agriculturally suitable cation. Examples of these salts are metal salts, in particular alkali metal salts or alkaline earth metal salts, in particular sodium and potassium salts, or else ammonium salts or salts with organic amines. Likewise, salt formation can be effected by an acid undergoing an addition reaction with basic groups, such as, for example, amino and alkylamino. Acids which are suitable for this purpose are strong inorganic and organic acids, for example HCl, HBr, H₂SO₄ or HNO₃.

Herbicides which are present in component (b1l) and/or (a3) which may be mentioned are, for example, ALS inhibitors (acetolactate synthetase inhibitors) or herbicides which differ from ALS inhibitors, such as herbicides from the group of the carbamates, thiocarbamates, haloacetanilides, substituted phenoxy-, naphthoxy- and phenoxyphenoxycarboxylic acid derivatives and heteroaryloxyphenoxyalkane-carboxylic acid derivatives such as quinolyloxy-, quinoxalyloxy-, pyridyloxy-, benzoxazolyloxy- and benzthiazolyloxyphenoxyalkanecarboxylic esters, cyclohexanedione derivatives, phosphorus-containing herbicides, for example of the glufosinate type or of the glyphosate type, and S-(N-aryl-N-alkylcarbamoylmethyl)-dithiophosphoric esters.

In particular, the ALS inhibitors take the form of imidazolinones, pyrimidinyloxy-pyridincarboxylic acid derivatives, pyrimidyloxybenzoic acid derivatives, triazolo-pyrimidinosulfonamide derivatives and sulfonamides, preferably from the group of the sulfonylureas.

Preferred ALS inhibitors are selected from the group consisting of the sulfonylureas, for example pyrimidine- or triazinylaminocarbonyl[benzene-, pyridine-, pyrazole-, thiophene- and (alkylsulfonyl)alkylamino]sulfamides. Preferred substituents on the pyrimidine ring or triazine ring are alkoxy, alkyl, haloalkoxy, haloalkyl, halogen or dimethylamino, it being possible for all substituents to be combined independently of one another. Preferred substituents in the benzene, pyridine, pyrazole, thiophene or (alkylsulfonyl)alkylamino moiety are alkyl, alkoxy, halogen such as F, Cl, Br or I, amino, alkylamino, dialkylamino, acylamino such as formylamino, nitro, alkoxycarbonyl, aminocarbonyl, alkylaminocarbonyl, dialkylaminocarbonyl, alkoxyaminocarbonyl, haloalkoxy, haloalkyl, alkylcarbonyl, alkoxyalkyl, alkylsulfonylaminoalkyl, (alkanesulfonyl)alkylamino. Examples of such sulfonylureas which are suitable are

A1) Phenyl- and benzylsulfonylureas and related compounds, for example 1-(2-chlorophenylsulfonyl)-3-(4-methoxy-6-methyl-1,3,5-triazin-2-yl)urea (chlorsulfuron), 1-(2-ethoxycarbonylphenylsulfonyl)-3-(4-chloro-6-methoxypyrimidin-2-yl)urea (chlorimuron-ethyl), 1-(2-methoxyphenylsulfonyl)-3-(4-methoxy-6-methyl-1,3,5-triazin-2-yl)urea (metsulfuron-methyl), 1-(2-chloroethoxyphenylsulfonyl)-3-(4-methoxy-6-methyl-l,3,5-triazin-2-yl)urea (triasulfuron), 1-(2-methoxycarbonylphenylsulfonyl)-3-(4,6-dimethylpyrimidin-2-yl)urea (sulfometuron-methyl), 1-(2-methoxycarbonylphenylsulfonyl)-3-(4-methoxy-6-methyl-1,3,5-triazin-2-yl)-3-methylurea (tribenuron-methyl), 1-(2-methoxycarbonylbenzylsulfonyl)-3-(4,6-dimethoxypyrimidin-2-yl)urea (bensulfuron-methyl), 1-(2-methoxycarbonylphenysulfonyl)-3-(4,6-bis(difluoromethoxy)pyrimidin-2-yl)-urea, (primisulfuron-methyl), 3-(4-ethyl-6-methoxy- 1,3,5-triazin-2-yl)-1-(2,3-dihydro-1,1-dioxo-2-methylbenzo-[b]thiophene-7-sulfonyl)urea (EP-A 0 796 83), 3-(4-ethoxy-6-ethyl-1,3,5-triazin-2-yl)-1-(2,3-dihydro-1,1-dioxo-2-methylbenzo[b]-thiophene-7-sulfonyl)urea (EP-A 0 079 683), 3-(4-methoxy-6-methyl-1,3,5-triazin-2-yl)-1-(2-methoxycarbonyl-5-iodophenyl-sulfonyl)urea (iodosulfurone-methyl and its salts such as the sodium salt, WO 92/13845), DPX-66037, triflusulfurone-methyl (Brighton Crop Prot. Conf.—Weeds—1995, p. 853), CGA-277476, (Brighton Crop Prot. Conf.—Weeds—1995, p. 79), methyl 2-[3-(4,6-dimethoxypyrimidin-2-yl)ureidosulfonyl]-4-methanesulfonamido-methylbenzoate (mesosulfuron-methyl and its salts such as the sodium salt, N,N-dimethyl-2-[3-(4,6-dimethoxypyrimidin-2-yl)ureidosulfonyl]-4-formylamino-benzamide (foramsulfuron and its salts such as the sodium salt, WO 95/01344);

A2) Thienylsulfonylureas, for example 1-(2-methoxycarbonylthiophen-3-yl)-3-(4-methoxy-6-methyl-1,3,5-triazin-2-yl)urea (thifensulfuron-methyl);

A3) Pyrazolylsulfonylureas, for example 1-(4-ethoxycarbonyl-1-methylpyrazol-5-yl-sulfonyl)-3-(4,6-dimethoxypyrimidin-2-yl)urea (pyrazosulfuron-methyl); methyl 3-chloro-5-(4,6-dimethoxypyrimidin-2-ylcarbamoylsulfamoyl)-1-methyl-pyrazole-4-carboxylate (EP-A 0 282 613); 5-(4,6-dimethylpyrimidin-2-yl-carbamoylsulfamoyl)-1-(2-pyridyl)pyrazole-4-carboxylate (NC-330, Brighton Crop Prot. Conference ‘Weeds’ 1991, Vol. 1, p. 45 ff.), DPX-A8947, azimsulfuron, (Brighton Crop Prot. Conf. ‘Weeds’ 1995, p. 65);

A4) Sulfonediamide derivatives, for example 3-(4,6-dimethoxypyrimidin-2-yl)-1-(N-methyl-N-methylsulfonylaminosulfonyl)urea (amidosulfuron) and its structural analogs (EP-A 0 131 258 and Z. Pfl. Krankh. Pfl. Schutz, Sonderheft XII, 489-497 (1990));

A5) Pyridylsulfonylureas, for example 1-(3-N, N-dimethylaminocarbonylpyridin-2-ylsulfonyl)-3-(4,6-dimethoxypyrimidin-2-yl) urea (nicosulfuron), 1-(3-ethylsulfonylpyridin-2-ysulfonyl)-3-(4,6-dimethoxypyrimidin-2-yl)urea (rimsulfuron), methyl 2-[3-(4,6-dimethoxypyrimidin-2-yl)ureidosulfonyl]-6-trifluoromethyl-3-pyridinecarboxylate, sodium salt (DPX-KE 459, flupyrsulfuron, Brighton Crop Prot. Conf. Weeds, 1995, p. 49), and trifloxysulfuron and its sodium salt;

A6) Alkoxyphenoxysulfonylureas as they are described for example in EP-A 0 342 569, preferably 3-(4,6-dimethoxypyrimidin-2-yl)-1-(2-ethoxyphenoxy)-sulfonylurea (ethoxysulfuron) or its salts;

A7) lmidazolylsulfonylureas, for example MON 37500, sulfosulfuron (Brighton Crop Prot. Conf. ‘Weeds’, 1995, p: 57), and other related sulfonylurea derivatives and mixtures of these.

Typical representatives of these active substances are, inter alia, the compounds listed hereinbelow and their salts: amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, flupyrsulfuron-methyl-sodium, halosulfuron-methyl, imazosulfuron, metsulfuron-methyl, nicosulfuron, oxasulfuron, primisulfuron-methyl, prosulfuron, pyrazosulfuron-ethyl, rimsulfuron, sulfometuron-methyl, sulfosulfuron, thifensulfuron-methyl, triasulfuron, tribenuron-methyl, triflusulfuron-methyl, trifloxysulfuron and its sodium salt, iodosulfuron-methyl and its sodium salt (WO 92/13845), mesosulfuron-methyl and its sodium salt (Agrow No. 347, 3 Mar. 2000, page 22 (PJB Publications Ltd. 2000)) and foramsulfuron and its sodium salt (Agrow No. 338, 15 Oct. 1999, page 26 (PJB Publications Ltd. 1999)).

The active substances listed above are known for example from “The Pesticide Manual”, 12th edition (2000), The British Crop Protection Council, or the references mentioned after the individual active substances.

Examples of further suitable ALS inhibitors are

B) Imidazolinones, for example methyl 2-(4-isopropyl-4-methyl-5-oxo-2-imidazolin-2-yl)-5-methylbenzoate and 2-(4-isopropyl-4-methyl-5-oxo-2-imidazolin-2-yl)-4-methylbenzoic acid (imazamethabenz), 5-ethyl-2-(4-isopropyl-4-methyl-5-oxo-2-imidazol in-2-yl)pyridine-3-carboxylic acid (imazethapyr), 2-(4-isopropyl-4-methyl-5-oxo-2-imidazolin-2-yl)quinoline-3-carboxylic acid (imazaquin), 2-(4-isopropyl-4-methyl-5-oxo-2-imidazolin-2-yl)pyridine-3-carboxylic acid (imazapyr), 5-methyl-2-(4-isopropyl-4-methyl-5-oxo-2-imidazolin-2-yl)pyridine-3-carboxylic acid (imazethamethapyr);

C) Triazolopyrimidinesulfonamide derivatives, for example N-(2,6-difluorophenyl)-7-methyl-1,2,4-triazolo[1,5-c]pyrimidine-2-sulfonamide (flumetsulam), N-(2,6-dichloro-3-methylphenyl)-5,7-dimethoxy-1,2,4-triazolo[1,5-c]pyrimidine-2-sulfonamide, N-(2,6-difluorophenyl)-7-fluoro-5-methoxy-1,2,4-triazolo[1,5-c]pyrimidine-2-sulfonamide, N-(2,6-dichloro-3-methylphenyl)-7-chloro-5-methoxy-1,2,4-triazolo[1,5-c]pyrimidi ne-2-sulfonamide, N-(2-chloro-6-methoxycarbonyl)-5,7-dimethyl-1,2,4-triazolo[1,5-c]pyrimidine-2-sulfonamide (EP-A 0 343 752, US-A 4,988,812);

D) Pyrimidinyloxypyridinecarboxylic acid and pyrimidinyloxybenzoic acid derivatives, for example benzyl 3-(4,6-dimethoxypyrimidin-2-yl)oxypyridine-2-carboxylate (EP-A 0 249 707), methyl 3-(4,6-dimethoxypyrimidin-2-yl)oxypyridine-2-carboxylate (EP-A 0 249 707), 2,6-bis[(4,6-dimethoxypyrimidin-2-yl)oxy]benzoic acid (EP-A 0 321 846), 1-(ethoxycarbonyloxyethyl) 2,6-bis[(4,6-dimethoxypyrimidin-2-yl)oxy]benzoate (EP-A 0 472 113).

The herbicidal active substances which are present in the components (b1) and/or (a3) and which differ from the ALS inhibitors are, for example, herbicides from the group of the carbamates, thiocarbamates, haloacetanilides, substituted phenoxy-, naphthoxy- and phenoxyphenoxycarboxylic acid derivatives, and heteroaryloxy-phenoxyalkanecarboxylic acid derivatives such as quinolyloxy-, quinoxalyloxy-, pyridyloxy-, benzoxazolyloxy- and benzothiazolyloxyphenoxyalkanecarboxylic esters, cyclohexanedione derivatives, and S-(N-aryl-N-alkylcarbamoylmethyl)-dithiophosphoric esters. Preferred in this context are phenoxy-,phenoxyphenoxy- and heteroaryloxyphenoxycarboxylic esters and their salts, and herbicides such as bentazone, cyanazine, atrazine, dicamba or hydroxybenzonitriles such as bromoxynil and ioxynil and other foliar-acting herbicides.

Suitable herbicidal active substances which differ from the ALS inhibitors and which may be present as component (b1) or (a3) are, for example:

E) Herbicides of the phenoxyphenoxy- and heteroaryloxyphenoxycarboxylic acid derivatives type, such as

E1) Phenoxyphenoxy- and benzyloxyphenoxycarboxylic acid derivatives, for example methyl 2-(4-(2,4-dichlorophenoxy)phenoxy)propionate (diclofop-methyl), methyl 2-(4-(4-bromo-2-chlorophenoxy)phenoxy)propionate (DE-A 26 01 548), methyl 2-(4-(4-bromo-2-fluorophenoxy)phenoxy)propionate (US-A 4,808,750), methyl 2-(4-(2-chloro-4-trifluoromethylphenoxy)phenoxy)propionate (DE-A 24 33 067), methyl 2-(4-(2-fluoro-4-trifluoromethylphenoxy)phenoxy)propionate (U.S. Pat. No. 4,808,750), methyl 2-(4-(2,4-dichlorobenzyl)phenoxy)propionate (DE-A 24 17 487), ethyl 4-(4-(4-trifluoromethylphenoxy)phenoxy)pent-2-enoate, methyl 2-(4-(4-trifluoromethylphenoxy)phenoxy)propionate (DE-A 24 33 067); E2) “Mononuclear” heteroaryloxyphenoxyalkanecarboxylic acid derivatives, for example ethyl 2-(4-(3,5-dichloropyridyl-2-oxy)phenoxy)propionate (EP-A 0 002 925), propargyl 2-(4-(3,5-dichloropyridyl-2-oxy)phenoxy)propionate (EP-A 0 003 114), methyl 2-(4-(3-chloro-5-trifluoromethyl-2-pyridyloxy)phenoxy)propionate (EP-A 0 003 890), ethyl 2-(4-(3-chloro-5-trifluoromethyl-2-pyridyloxy)phenoxy)propionate (EP-A 0 003 890), propargyl 2-(4-(5-chloro-3-fluoro-2-pyridyloxy)phenoxy)propionate (EP-A 0 191 736), butyl 2-(4-(5-trifluoromethyl-2-pyridyloxy)phenoxy)propionate (fluazifop-butyl);

E3) “Binuclear” heteroaryloxyphenoxyalkanecarboxylic acid derivatives, for example methyl and ethyl 2-(4-(6-chloro-2-quinoxalyloxy)phenoxy)propionate (quizalofop-methyl and quizalofop-ethyl), methyl 2-(4-(6-fluoro-2-quinoxalyloxy)phenoxy)propionate (see J. Pest. Sci. Vol. 10, 61 (1985)), 2-isopropylideneaminooxyethyl 2-(4-(6-chloro-2-quinoxalyloxy)phenoxy)propionate (propaquizafop), ethyl 2-(4-(6-chlorobenzoxazol-2-yloxy)phenoxy)propionate (fenoxaprop-ethyl), its D(+) isomer (fenoxaprop-P-ethyl) and ethyl 2-(4-(6-chlorobenzothiazol-2-yloxy)phenoxy)propionate (DE-A 26 40 730), tetrahydro-2-furylmethyl 2-(4-(6-chloroquinoxalyloxy)phenoxy)propionate (EP-A 0 323 727);

E4) Phenoxycarboxylic acid derivatives such as 2,4-D, 2,4-DP, 2,4-DB, CMPP and MCPA and their esters and salts;

F) Chloroacetanilides, for example N-methoxymethyl-2,6-diethylchloroacetanilide (alachlor), N-(3-methoxyprop-2-yl)-2-methyl-6-ethylchloroacetanilide (metolachlor), 2,6-dimethyl-N-(3-methyl- 1,2,4-oxadiazol-5-ylmethyl)chloroacetanilide, N-(2,6-dimethylphenyl)-N-(1-pyrazolylmethyl)chloroacetamide (metazachlor);

G) Thiocarbamates, for example S-ethyl N,N-dipropylthiocarbamate (EPTC), S-ethyl N,N-diisobutylthiocarbamate (butylate);

H) Cyclohexanedione oximes, for example methyl 3-(1-allyloxyiminobutyl)-4-hydroxy-6,6-dimethyl-2-oxocyclohex-3-enecarboxylate (alloxydim), 2-(1-ethoxyiminobutyl)-5-(2-ethylthiopropyl)-3-hydroxycyclohex-2-en-1-one (sethoxydim), 2-(1-ethoxyiminobutyl)-5-(2-phenylthiopropyl)-3-hydroxycyclohex-2-en-1-one (cloproxydim), 2-(1-(3-chloroallyloxy)iminobutyl)-5-(2-ethylthiopropyl)-3-hydroxycyclohex-2-en-1-one, 2-(1-(3-chloroallyloxy)iminopropyl)-5-(2-ethylthiopropyl)-3-hydroxycyclohex-2-en-1-one (clethodim), 2-(1-ethoxyiminobutyl)-3-hydroxy-5-(thian-3-yl)cyclohex-2-enone (cycloxydim), 2-(1-ethoxyiminopropyl)-5-(2,4,6-trimethylphenyl)-3-hydroxycyclohex-2-en-1-one (tralkoxydim);

I) Benzoylcyclohexanediones, for example 2-(2-chloro-4-methylsulfonylbenzoyl)cyclohexane-1,3-dione (SC-0051, EP-A 0 137 963), 2-(2-nitrobenzoyl)-4,4-dimethylcyclohexane-1,3-dione (EP-A 0 274 634), 2-(2-nitro-4-methylsulfonylbenzoyl)-4,4-dimethylcyclohexane-1,3-dione (WO-A-91/13548, mesotrione);

J) S-(N-Aryl-N-alkylcarbamoylmethyl) dithiophosphonates such as S-[N-(4-chlorophenyl)-N-isopropylcarbamoylmethyl] O,O-dimethyl dithiophosphate (anilophos).

K) Alkylazines, for example as described in WO-A 97/08156, WO-A-97/31904, DE-A-19826670, WO-A-98/15536, WO-A-8/15537, WO-A-98/15538, WO-A-98/15539 and also DE-A-19828519, WO-A-98/34925, WO-A-98/42684, WO-A-99/18100, WO-A-99/19309, WO-A-99/37627 and WO-A-99/65882, preferably those of the formula (I)

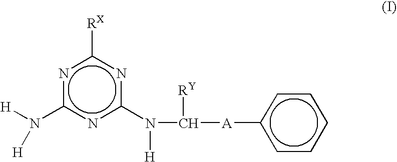

in which

R^{X} is (C₁-C₄)alkyl or (C₁-C₄)haloalkyl;

R^{Y} is (C₁-C₄)alkyl, (C₃-C₆)cycloalkyl or (C₃-C₆)cycloalkyl(C₁-C₄)alkyl and

A is —CH₂—, —CH₂—CH₂—, —CH₂—CH₂—CH₂—, —O—, —CH₂—CH₂—O—, —CH₂—CH₂—CH₂—O—, especially preferably those of the formula I1-I7

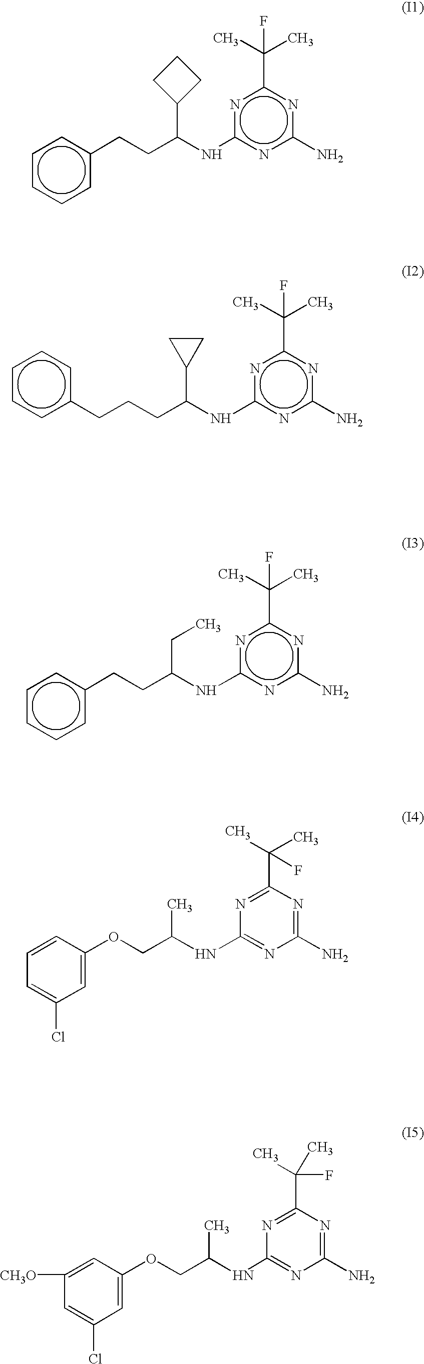

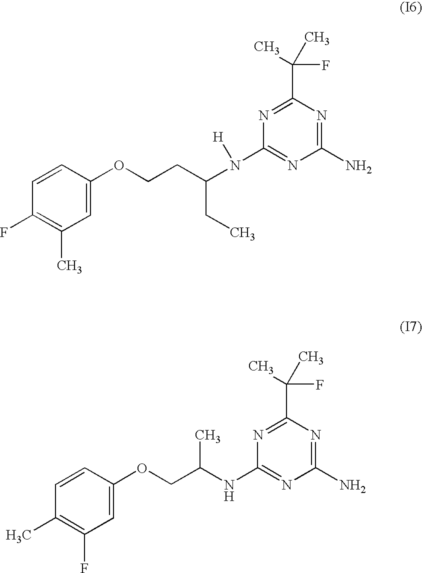

The herbicides of groups B to K are known, for example, from each of the specifications stated above and from “The Pesticide Manual”, ₁₂th Edition, 2000, The British Crop Protection Council, “Agricultural Chemicals Book II—Herbicides—”, by W. T. Thompson, Thompson Publications, Fresno Calif., USA 1990 and “Farm Chemicals Handbook '90”, Meister Publishing Company, Willoughby OH, USA,1990.

Preferred examples of the herbicides present as component (b1l) and/or (a3) are compounds from the group of the (5-hydroxy-1,3-dimethyl-1H-pyrazol-4-yl)[2-(methylsulfonyl)-4-(trifluoromethyl)phenyl]methanones and N-[(1R,2S)-2,6-dimethyl-2,3-dihydro-1H-inden-1-yl]-6-[(1R)-1-fluoroethyl]-1,3,5-triazine-2,4-diamines, and their other optically active alternatives; in addition compounds from the groups of the sulfonylureas, phenylureas such as, for example, diuron, IPU, linuron; HPPD inhibitors, triketones, safeners, phenoxy esters, diclofop, fenoxaprop, oxyacetamides such as, for example, flufenacet, and beet herbicides such as, for example, phenmedipham, desmedipham and metamitron, and also fluratom.

In this context, either no, one or more than one active substance(s) may be present in the water phase (a) in dissolved and/or dispersed form, and one or more active substance(s), also comprising the group of what is known as the “safeners”, may be present in the oil phase (b) in dissolved and/or dispersed form, the W/O suspo-emulsion preferably comprising at least two active substances, at least one of which being present in dispersed form.

Suitable active substances for the water phase (component (a3)) can preferably be water-soluble active substances, but also active substances which are insoluble in water and are dispersible in the water phase.

Examples of agrochemical active substances which can be suitable, preferably from the group of the herbicides, are those from the following groups: salts of phenylacetic, phenylpropionic, phenylbutyric or isobutyric acid derivatives (also optically active forms); salts of bromoxynil derivatives or ioxynil derivatives, phenylureas such as, for example, diuron, IPU, linuron; beet herbicides such as, for example, phenmedipham, desmedipham, ethofumesate, metamitron; herbicides such as (5-hydroxy-1,3-dimethyl-1H-pyrazol-4-yl)[2-(methylsulfonyl)-4-(trifluoro- methyl)phenyl]methanone and N-[(1R,2S)-2,6-dimethyl-2,3-dihydro-1H-inden-1-yl]-6-[(1R)-1-fluoroethyl]-1,3,5-triazine-2,4-diamine, and their other optically active alternatives), fluratom, flufenacet, or those which are insoluble in water but which are soluble in the oil phase (b) and/or dispersible in the water phase (a).

The total active substance content in the ready-to-use formulation amounts to 1-49% by weight, preferably 5-33% by weight, and very specially preferably 6-28% by weight.

Examples of surfactants which are suitable as component (a4) are the following. Surfactants from the group of the anionic or nonionic surfactants, for example those listed hereinbelow, wherein EO=ethylene oxide units, PO=propylene oxide units and BO=butylene oxide units:

1) C₁-C₂₂-alcohols which may be alkoxylated, for example with 1-60 alkylene oxide units, preferably 1-60 EO and/or 1-30 PO and/or 1-15 BO, in any desired order. The terminal hydroxyl groups of these compounds may be end-capped by an alkyl, cycloalkyl or an acyl radical having 1-24 carbon atoms.
Examples of such compounds are:
Genapol® C, L, O, T, UD, UDD, X brands from Clariant, Plurafac® and Lutensol®A, AT, ON, TO brands from BASF, Marlipal®24 and 13 brands from Condea, Dehypon® brands from Henkel, Ethylan® brands from Akzo-Nobel such as Ethylan CD 120.

2) Anionic derivatives of the brands described under 1) in the form of sulfonates, sulfates and phosphates and their inorganic salts (for example alkali metal and alkaline earth metal salts) and organic salts (for example based on amines or alkanolamines) such as Genapol®LRO, Sandopan® brands, Hostaphat/Hordaphos® brands from Clariant.
Copolymers consisting of EO, PO and/or BO units such as, for example, block copolymers such as the Pluronice products from BASF and the Synperonic® brands from Uniquema with a molecular weight of from 400 to 10⁸. Alkylene oxide adducts of C₁-C₉-alcohols such as Atlox®5000 from Uniquema or Hoe®-S3510 from Clariant.

3) Fatty acid and triglyceride alkoxylates such as the Serdox®NOG brands from Condea, or alkoxylated vegetable oils such as soya oil, rapeseed oil, corn oil, sunflower oil, cottonseed oil, linseed oil, coconut oil, palm oil, safflower oil, walnut oil, peanut oil, olive oil or castor oil, in particular rapeseed oil, vegetable oils also being understood as meaning their transesterification products, for example alkyl esters such as rapeseed oil methyl ester or rapeseed oil ethyl ester, for example the Emulsogen® brands from Clariant, salts of aliphatic, cycloaliphatic and olefinic carboxylic acids and polycarboxylic acids, and alpha-sulfo-fafty acid esters such as those available from Henkel.

4) Fatty amide alkoxylates such as the Comperlan® brands from Henkel or the Amam® brands from Rhodia.
Alkylene oxide adducts of alkynediols such as the Surfynol brands from Air Products. Sugar derivatives such as aminosugars and amidosugars from Clariant, glucitols from Clariant, alkyl polyglycosides in the form of the APG® brands from Henkel or such as sorbitan esters in the form of the Span® or Tween® brands from Uniquema or cyclodextrin esters or cyclodextrin ethers from Wacker.

5) Surface-active cellulose and algin, pectin and guar derivatives such as the Tylose® brands from Clariant, the Manutex® brands from Kelco and guar derivatives from Cesalpina.

Polyol-based alkylene oxide adducts, such as Polyglykol® brands from Clariant. Surface-active polyglycerides and their derivatives from Clariant.

6) Sulfosuccinates, alkanesulfonates, paraffin- and olefinsulfonates such as Netzer IS®, Hoe®S1728, Hostapur®OS, Hostapur®SAS from Clariant, Triton®GR7ME and GR5 from Union Carbide, Empimin ) brands from Albright and Wilson, Marlon®-PS65 from Condea.

7) Sulfosuccinamates such as the Aerosol brands from Cytec or the Empimin brands from Albright and Wilson.

8) Alkylene oxide adducts of fatty amines, quaternary ammonium compounds having 8 to 22 carbon atoms (C₈-C₂₂) such as, for example, the Genamin®C, L, O ,T brands from Clariant.

9) Silicone- or silane-based surface-active compounds such as the Tegopren® brands from Goldschmidt and the SE® brands from Wacker and also the Bevaloid®, Rhodorsil® and Silcolapse® brands from Rhodia (Dow Corning, Reliance, GE, Bayer).

10) Perfluorinated or polyfluorinated surface-active compounds such as Fluowet® brands from Clariant, the Bayowet® brands from Bayer, the Zonyl® brands from DuPont and products of this type from Daikin and Asahi Glass.

11) Surface-active sulfonamides, for example from Bayer.

12) Surface-active polyacrylic and polymethacrylic derivatives such as the Sokalan® brands from BASF.

13) Surface-active polyamides such as modified gelatin or derivatized polyaspartic acid from Bayer, and their derivatives.

14) Surfactant polyvinyl compounds such as modified polyvinylpyrrolidone, such as the Luviskol® brands from BASF and the Agrimer brands from ISP or the derivatized polyvinyl acetates such as the Mowilith® brands from Clariant or the polyvinyl butyrates such as the Lutonal® brands from BASF, the Vinnapas® and the Pioloform® brands from Wacker or modified polyvinyl alcohols such as the Mowiol brands from Clariant.

15) Surface-active polymers based on maleic anhydride and/or reaction products of maleic anhydride, and copolymers comprising maleic anhydride and/or reaction products of maleic anhydride, such as Agrimer®-VEMA brands from ISP.

16) Surface-active derivatives of montan, polyethylene and polypropylene waxes such as the Hoechst® waxes or the Licowet® brands from Clariant.

17) Surface-active phosphonates and phosphinates such as Fluowet®-PL from Clariant.

18) Polyhalogenated or perhalogenated surfactants such as, for example, Emulsogen®-1557 from Clariant.

19) Phenols which may be alkoxylated, for example phenyl-(C₁-C₄)alkyl ethers or (poly)alkoxylated phenols [=phenol (poly)alkylene glycol ethers], for example having 1 to 50 alkyleneoxy units in the (poly)alkyleneoxy moiety, the alkylene moiety preferably having in each case 1 to 4 carbon atoms, preferably phenol reacted with 3 to 10 mol alkylene oxide, (poly)alkylphenols or (poly)alkylphenol alkoxylates [=polyalkylphenol(poly)alkylene glycol ethers], for example having 1 to 12 carbon atoms per alkyl residue and 1 to 150 alkyleneoxy units in the polyalkyleneoxy moiety, preferably tri-n-butylphenol or triisobutylphenol reacted with 1 to 50 mol ethylene oxide, polyarylphenols or polyarylphenol alkoxylates [=polyarylphenol(poly)alkylene glycol ether], for example tristyrylphenol polyalkylene glycol ethers having 1 to 150 alkyleneoxy units in the polyalkyleneoxy moiety, preferably tristyrylphenol reacted with 1 to 50 mol ethylene oxide.

20) Compounds which formally constitute the reaction products of the molecules described under 20) with sulfuric acid or phosphoric acid and their salts which have been neutralized with suitable bases, for example the acid phosphoric ester of triethoxylated phenol, the acid phosphoric ester of a nonylphenol reacted with 9 mol of ethylene oxide, and the triethanolamine-neutralized phosphoric ester of the reaction product of 20 mol of ethylene oxide and 1 mol of tristyrylphenol.

21) Benzenesulfonates such as alkyl- or arylbenzenesulfonates, for example acid (poly)alkyl- and (poly)arylbenzenesulfonates and those neutralized with suitable bases, for example having 1 to 12 carbon atoms per alkyl residue and/or up to 3 styrene units in the polyaryl moiety, preferably (linear) dodecylbenzenesulfonic acid and its oil-soluble salts such as, for example, the calcium salt, or the isopropoylammonium salt of dodecylbenzenesulfonic acid. Preferred among the alkyleneoxy units are ethyleneoxy (EO), propyleneoxy (PO) and butyleneoxy (BO) units, in particular ethyleneoxy units.

Examples of preferred surfactants are those from the group of the nonaromatic-based surfactants, for example the surfactants of the above groups 1) to 18), preferably of the groups 1), 2), 6) and 8).

Examples of preferred surfactants are those from the group of the aromatic-based surfactants, for example the surfactants of the abovementioned groups 19) to 21), preferably

phenol which has been reacted with 4 to 10 mol of ethylene oxide, commercially available for example in the form of the Agrisol® products (Akcros), truisobutylphenol which has been reacted with 4 to 50 mol of ethylene oxide, commercially available for example in the form of the Sapogenat® T products (Clariant),

nonylphenol which has been reacted with 4 to 50 mol of ethylene oxide, commercially available for example in the form of the Arkopal® products (Clariant), tristyrylphenol which has been reacted with 4 to 150 mol of ethylene oxide, for example from the Soprophor® series such as Soprophor® FL, Soprophor® 3D33, Soprophor® BSU, Soprophor® 4D-384, Soprophor® CY/8 (Rhodia), and acid (linear) dodecylbenzenesulfonate, commercially available for example in the form of the Marion® products (HOls).

Suitable surfactants in the water phase (component (a4)) are, for example, anionic- and/or nonionic-based surfactants. The surfactants in the oil phase (component (b2)) may be of the anionic or nonionic type.

The oil phase (b) comprises, as component (b2), one or more surfactants from the group of the alkoxylated tristyrylphenols which can be for example ethoxylated and/or propoxylated and/or butoxylated, calcium dodecylbenzenesulfonate or the alkoxylated C₁-C₂₂-alcohols, linear and/or branched, preferably C₈-C₁₈-alcohols, especially preferably C₁₀-C₁₄-alcohols (for example isotridecyl alcohol), which can be for example ethoxylated and/or propoxylated and/or butoxylated. The above-mentioned alkylene oxides, preferably mono-, bi- and polyfunctional alcohols, can additionally be phosphated and/or sulfated and/or sulfonated and neutralized with alkali or with amines. The alkylene oxide units (EO stands for ethoxylated, PO for propoxylated and BO for butoxylated) can amount to between 2-100, preferably 3-50 and especially preferably 4-30. Examples are Soprophore BSU, -4D384,-3D33,-FL, -FL-K, -CY/8,-S 25,-S 40,-FL 60 from Rhodia, Hoe S 3474, Hoe S 3475, Hoe S 3775, and the Genapol® X series from Clariant or the Lutensol® TO types from BASF or the Ethylanes® from Akzo-Nobel.

The total surfactant content in the ready-to-use formulation can amount to 0.1-45% by weight, preferably 0.8-25% by weight and very specially preferably 1-20% by weight, the amount of component (a1) amounting to 0.1-10% by weight, preferably 0.5-5% by weight, and component (b2) amounting to 0.1-20% by weight, preferably 1.0-14% by weight.

In addition to the components (b1) and (b2), the oil phase (b) additionally comprises organic carrier media (b3), for example aromatic-, heteroaromatic- and/or nonaromatic-based solvents, and also thickeners (b4) and, optionally, further adjuvants (b5) such as scents, colorants, antifoams, crystallization inhibitors and adhesives.

The active substances may be present in the organic carrier media either in dissolved and/or in dispersed form, the organic carrier media themselves not being water-soluble.

Organic carrier media for the oil phase (component (b3)) which are suitable are: aromatic and heteroaromatic solvents such as acetophenone, xylenes, toluene, naphthalenes, cumenes, alkylbenzenes, substances from the Solvesso® series from Exxon, anisoles, esters of aromatic carboxylic acids (such as benzoic esters, cinnamic esters, alkylphenyl carboxylic esters), mesitylene, pyridines and the like. Others which may be mentioned are nonaromatic carrier media such as paraffins, ketones, acid amides, amines, lactams, lactones, acid anhydrides, carboxylic esters, ethers, phosphoric esters, cyclic hydrocarbons (such as cyclohexane, decalin), terpenes, alcohols (such as isooctanol, dodecanol, decanol, isodecanol) and the like.

The organic carrier media amount to between 2-90% by weight, preferably 3-80% by weight, in the total ready-to-use formulation.

Examples of suitable thickeners for the oil phase (component (b4)) are:

1) modified natural silicates, such as chemically modified, for example hydrophobicized bentonites, hectorites, attapulgites, montmorillonites, smectites or other silicate minerals, such as Bentone® (Elementis, for example Bentone 27, 34, 38, SD1, SD2, EW), Attagel® (Engelhard), Agsorb® (Oil-Dri Corporation) or Hectorite® (Akzo Nobel), 2) synthetic silicates, such as silicates of the Sipernat6, Aerosilo or Durosilo series (Degussa), from the CAB-O-SIL® series (Cabot) or from the Van Gel series (R. T. Vanderbilt),

3) thickeners which are based on synthetic polymers, such as thickeners from Thixin® or Thixatrol® series (Elementis),

4) thickeners which are based on natural polymers and natural oils, for example from the Thixin® or Thixatrol® series (Elementis).

Preferred thickeners are, for example, modified, for example hydrophobicized, layer silicates and thickeners based on synthetic polymers.

If thickeners are present in the water-in-oil suspoemulsions according to the invention, their weight generally accounts for 0.01-5% by weight, in particular 0.1-3% by weight.

Furthermore, up to 20% by weight of customary adjuvants and additives may be present in the total ready-to-use formulation as components (b5) and/or (a5), such as commercially available auxiliaries such as wetters, dispersants, antifoams, preservatives and antifreeze agents, inter alia.

Additional wetters and dispersants which are suitable are, for example, tributylphenol polyglycol ethers, such as the Sapogenat® T brands (Hoechst) or nonylphenol polyglycol lethers, such as the Arkopale N brands (Hoechst).

Suitable antifoams are, for example, silicone-based antifoams such as those from the Silcolapse® series (Rhone Poulenc), SE 39 or Antischaummittel SH (Wacker).

If required, preservatives, for example preservatives based on formaldehyde, benzoic acid and triphenyltin, are used, such as, for example, Kobate® C.

Furthermore, it is also possible to add antifreeze agents such as urea, salts, especially potassium salts of phosphoric acid (KPO₄H₂, K₂PO₄H, K₃PO₄), polyols (for example glycol, propylene glycol or glycerol) or sugars.

The oil phase (b), which per se is also subject-matter of the invention, comprising components (b1), (b2), (b3), (b4) and, if appropriate, (b5) in accordance with the above definition, can be applied in dilute form either directly and/or as what is known as a “preparation”, such as, for example, a spray mixture, which is obtainable by dilution with further fluids which are suitable for this purpose, preferably water.

The oil-phase (b) according to the invention per se can be used for the preparation of stable ready-to-use formulations of active substances, inter alia of active substances as have already been mentioned above as components (b1) and/or (a3) (inter alia from the sectors agriculture/agrochemistry and veterinary medicine, where they can take the form of agrochemical active substances, such as, for example, herbicidal, insecticidal or fungicidal active substances or safeners).

The ready-to-use formulations according to the invention, which are understood as meaning not only the water-in-oil suspoemulsion according to the invention, consisting of water phase (a) and specific oil phase (b), but also the oil phase (b) according to the invention per se, and preparations which can be obtained with these ready-to-use formulations (for example spray mixtures) which can be obtained by diluting them with further fluids which are suitable for this purpose, preferably water, and which can then be applied in more dilute form, can be used for example for controlling undesired plant growth.

Specifically in the field of agrochemistry, the ready-to-use formulations according to the invention and preparations obtainable therefrom (for example spray mixtures) and the like have an outstanding herbicidal activity against a broad spectrum of economically important monocotyledonous and dicotyledonous harmful plants, depending on the active substance. They also act efficiently on perennial weeds which produce shoots from rhizomes, rootstocks or other perennial organs and which are difficult to control. In this context, it does not matter whether the ready-to-use formulations and their herbicidal preparations are applied before sowing, pre-emergence or post-emergence. Specific examples may be mentioned of some representatives of the monocotyledonous and dicotyledonous weed flora which can be controlled by the ready-to-use formulations and their preparations, without the enumeration being a restriction to certain species.

Examples of weed species on which the herbicidal compositions act efficiently are, from amongst the monocotyledonous weed species, Apera spica venti, Avena spp., Alopecurus spp., Brachiaria spp., Digitaria spp., Lolium spp., Echinochloa spp., Panicum spp., Phalaris spp., Poa spp., Setaria spp. and also Bromus spp. such as Bromus catharticus, Bromus secalinus, Bromus erectus, Bromus tectorum and Bromus japonicus and Cyperus species, from the annual group, and, among the perennial species, Agropyron, Cynodon, Imperata and Sorghum and also perennial Cyperus species. In the case of the dicotyledonous weed species, the spectrum of action extends to genera such as, for example, Abutilon spp., Amaranthus spp., Chenopodium spp., Chrysanthemum spp., Galium spp. such as Galium aparine, lpomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., amongst the annuals, and Convolvulus, Cirsium, Rumex and Artemisia in the case of the perennial weeds.

The ready-to-use formulations and their preparations also act outstandingly efficiently on harmful plants which are found under the specific cultures condition in rice, such as, for example, Echinochloa, Sagittaria, Alisma, Eleocharis, Scirpus and Cyperus.

If the ready-to-use formulations and their preparations are applied to the surface of the soil before germination, the weed seedlings are either prevented completely from emerging or else the weeds grow until they have reached the cotyledon stage, but then their growth stops, and, eventually, after three to four weeks have elapsed, they die completely.

If the ready-to-use formulations and their preparations are applied post-emergence to the green parts of the plants, growth likewise stops drastically a very short time after the treatment, and the weed plants remain at the growth stage of the point of time of application, or they die completely after a certain time, so that in this manner competition by the weeds, which is harmful to the crop plants, is eliminated very early and in a sustained manner.

The ready-to-use formulations and their preparations are distinguished by a herbicidal activity with a rapid onset and long duration of action. The rain fastness of the active substances in the ready-to-use formulations and their preparations is, as a rule, advantageous. A particular advantage is the fact that the dosages of herbicidal compounds which are used and effective in the ready-to-use formulations and their preparations can be set at such a low level that their soil action is optimally low. Thus, their use in sensitive crops is not only made possible in the first place, but groundwater contamination is virtually avoided. The combination according to the invention of active substances makes it possible to considerably reduce the required application rate of the active substances.

The abovementioned characteristics and advantages are useful in weed control practice in order to keep agricultural crops free of undesired plant competition and thus to safeguard and/or increase yields in terms of quality and quantity. The novel ready-to-use formulations and their preparations markedly exceed the prior art with regard to the above-described properties.

Even though the ready-to-use formulations and their preparations have an outstanding herbicidal activity against undesired monocotyledonous and dicotyledonous harmful plants, crop plants of economically important crops such as, dicotyledonous crops such as soya, cotton, oilseed rape, sugar beet, or graminaceous crops such as wheat, barley, rye, oats, millet/sorghum, rice or maize, are harmed only to a minor extent, if at all. For these reasons, the present ready-to-use formulations and their preparations are highly suitable for the selective control of undesired vegetation in stands of agriculturally useful plants or of ornamentals.

In addition, the relevant ready-to-use formulations and their preparations have outstanding growth-regulatory properties in crop plants. They engage in the plants' metabolism in a regulatory manner and can thus be employed for influencing plant constituents in a targeted manner and for facilitating harvesting such as, for example, by triggering desiccation and stunted growth. Moreover, they are also suitable for generally controlling and inhibiting undesired vegetative growth without destroying the plants in the process. Inhibiting the vegetative growth plays an important role in a large number of mono- and dicotyledonous crops since lodging can thus be reduced, or prevented completely.

Owing to their herbicidal and plant-growth regulatory properties, the ready-to-use formulations and their preparations can also be employed for controlling harmful plants in crops of genetically modified plants which are known or yet to be developed. As a rule, the transgenic plants are distinguished by particular advantageous properties, for example by resistances to certain pesticides, especially certain herbicides, resistances to plant diseases or to plant pathogens such as certain insects or microorganisms such as fungi, bacteria or viruses. Other particular properties concern for example the harvested material with regard to quantity, quality, storeability, composition and specific constituents. Thus, transgenic plants with an increased starch content or with a modified starch quality or with a different fatty acid composition of the harvested material are known.

The use of the ready-to-use formulations and their preparations in economically important transgenic crops of useful plants and ornamentals, such as of graminaceous crops such as wheat, barley, rye, oats, sorghum/millet, rice and maize or else crops of sugar beet, cotton, soybean, oilseed rape, potato, tomato, pea and other vegetables is preferred. The ready-to-use formulations and their preparations may preferably be employed in crops of useful plants which are resistant to the phytotoxic effects of the herbicides or which have been rendered resistant to the phytotoxic effects of the herbicides by recombinant means.

When the ready-to-use formulations and their preparations are used in transgenic crops, effects are frequently observed, in addition to the effects against harmful plants observed in other crops, which are specific for the application in the transgenic crop in question, for example a modified or specifically extended weed spectrum which can be controlled, altered application rates which can be employed for application, preferably good combining properties with the further herbicides to which the transgenic crop is resistant, and an effect on growth and yield of the transgenic crop plants. A method of controlling undesired vegetation is thus also an object of the present invention, preferably in crops such as cereals (e.g. wheat, barley, rye, oats, rice, maize, millet/sorghum), sugar beet, sugar cane, oilseed rape, cotton and soybean, particularly preferably in monocotyledonous crops such as cereals, e.g. wheat, barley, rye, oats hybrids thereof such as triticale, rice, maize and millet/sorghum which comprises applying the ready-to-use formulations according to the invention, by which both the water-in-oil suspoemulsion according to the invention consisting of water phase (a) and specific oil phase (b), and the oil phase (b) according to the invention per se are meant, and their preparations to the harmful plants, plant parts, plant seeds or the area where the plants grow e.g. the area under cultivation.

The W/O suspoemulsions according to the invention are prepared for example by providing the oil phase (b), into which the water phase (a) is mixed. Mixing the components with one another gives rise to a suspoemulsion with the oil phase (b) as carrier phase, while the water phase (a) is emulsified in the form of distributed droplets, the amount of the oil phase (b), if present in the mixture, accounting for 20-99% by weight, preferably 35-80% by weight, and the amount of the water phase (a) accounting for 1-80% by weight, preferably 20-65% by weight. The fact that a W/O suspoemulsion is indeed present can be verified by means of viewing under the microscope and conductivity measurements.

The oil phase (b) is prepared by adding, to the stirred carrier medium (b3), the relevant surfactants (b2), thickeners (b4), auxiliaries and/or additives (b5) and, finally, the active substance(s), during which process the components mix. In the case of active substances which are to be dispersed, the mixture is subjected for example to wet-milling in order to comminute the active substance particles.

When preparing the water phase (a), a procedure as for the preparation of the oil phase (b) is followed, the components likewise being mixed and water being used as the carrier medium.

The preparations such as, for example, spray mixtures, of the ready-to-use formulations according to the invention, which is understood as meaning both the water-in-oil suspoemulsion according to the invention, consisting of water phase (a) and specific oil phase (b), and the oil phase (b) according to the invention per se, are obtainable by dilution with further suitable fluids, preferably water.

The water-in-oil suspoemulsions according to the invention and the oil phase (b) according to the invention which they comprise are advantageously with regard to higher active substance concentrations (“loading density”) in the availability of individual active substances in the ready-to-use formulations and in an increased storage stability.

In particular using the composition according to the invention in the oil phase (b) and/or preparations therefrom, it is possible to prepare stable active substance ready-to-use formulations of active substances (component (b1)), for example those which can be employed in the sectors agriculture/agrochemistry and veterinary medicine; with in each case good biological and use characteristics in the case of agrochemical active substances such as, for example, herbicidal, insecticidal or fungicidal active substances.

Besides, in the case of optionally used active substances (component (a3)) in the preferably mentioned water phase (a), for example salt-like active substances which are dissolved in water, the very complicated milling process can be dispensed with, which simultaneously avoids separations as the result of unduly large differences in density.

### EXAMPLES

Tables 1 and 2 which follow describe examples of W/O suspoemulsions according to the invention (table 1) and oil phases according to the invention (table 2), without the invention being limited thereto.

Table 1 describes W/O suspoemulsions according to the invention, composed of different oil phases (b) according to the invention and different water phases (a).

Table 2 describes the composition of a variety of oil phases according to the invention.

TABLE 1
W/O suspoemulsions

| | | Example No. | | | | | | | | | | |
|---|---|---|---|---|---|---|---|---|---|---|---|---|
| Components | | 1 | 2 | 3 | 4 | 5 | 6 | 7 | 8 | 9 | 10 | 11 |
| a | Water | 29 | 29 | 29 | 30.0 | 24.0 | 24.5 | 24.5 | 24.5 | 24.5 | 24.5 | 24.5 |
| a1 | Geropon ® T/36 | 1 | 1 | | 1 | 1 | 1 | 1 | 1 | 1 | 1 | 1 |
| a1 | Geronol ® RP/7425 | | 3 | 3 | | | | | | | | |
| a2 | Ammonium sulfate | 22 | 22 | 22 | 21.80 | 17.50 | 17.70 | 17.70 | 17.85 | | | |
| a2 | K₂HPO₄ | | | | | | | | | 17.70 | 17.70 | 17.85 |
| a3/ | Active substance A | 5.2 | 5.2 | 5.2 | 10.3 | 5.18 | 3.48 | 6.93 | 4.38 | 3.48 | 6.93 | 4.38 |
| b1 | (dispersed) | | | | | | | | | | | |
| b1 | Fenoxaprop-P | 4.2 | 4.2 | 4.2 | | 5.62 | 5.68 | 5.66 | 5.72 | 5.68 | 5.66 | 5.72 |
| b1 | Mefenpyr (safener) | 1.7 | 1.7 | 1.7 | 1.14 | 2.10 | 2.12 | 2.31 | 2.13 | 2.12 | 2.31 | 2.13 |
| b2 | Soprophor ® 4D384 | 2 | | 4 | 2 | 2 | 2 | 2 | 2 | 2 | 2 | 2 |
| b2 | Calsogen ® AR 100 | | | | 3 | 3 | 3 | 3 | 3 | 3 | 3 | 3 |
| | ND | | | | | | | | | | | |
| b2 | Emulsogen ® EL 400 | 3 | | | | | | | | | | |
| b2 | Genapol ® X 150 | 4 | 4 | | 4 | 4 | 4 | 4 | 4 | 4 | 4 | 4 |
| b2 | Genapol ® X 060 | | | 4 | | | | | | | | |
| b2 | Soprophor ® CY/8 | 3 | 3 | 3 | 3 | 3 | 3 | 3 | 3 | 3 | 3 | 3 |
| b2 | Soprophor ® BSU | | | 2 | | | | | | | | |
| b3 | Rapeseed oil, | 2.5 | 2.5 | 3 | 2.5 | 2.5 | 2.5 | 2.5 | 2.5 | 2.5 | 2.5 | 2.5 |
| | refined | | | | | | | | | | | |
| b4 | Bentone ® SD1 | 1 | 1 | 1 | 0.5 | 0.75 | 1 | 1 | 1 | 1 | 1 | 1 |
| b5 | Edenol ® D 81 | 2 | 2 | 2 | | 2 | 2 | 2 | 2 | 2 | 2 | 2 |
| b3 | Solvesso ® 200 ND | to 100 | to 100 | to 100 | to 100 | to 100 | to 100 | to 100 | to 100 | to 100 | to 100 | to 100 |

All data in % by weight
Active substance A: (5-hydroxy-1,3-dimethyl-1H-pyrazol-4-yl)[2-(methylsulfonyl)-4-(trifluoromethyl)phenyl]methanone
Geropon ® T/36: Sodium polycarboxylate
Geronol ® RP/7425: Mixture of linear calcium dodecylbenzenesulfonate (CaDBS) + tristyrylphenol ethoxylate
Soprophor ® 4D384: Ethoxylated + sulfated tristyrylphenol
Calsogen ® AR 100 ND: CaDBS in Solvesso ND
Emulsogen ® EL 400: Castor oil with 40 EO
Genapol ® X 150: Isotridecyl alcohol with 15 EO
Genapol ® X 060: Isotridecyl alcohol with 6 EO
Soprophor ® CY/8: Tristyrylphenol with 20 EO
Soprophor ® BSU: Tristyrylphenol with 16 EO
Bentone ® SD1: Alumolayer silicate
Edenol ® D 81: Epoxidized soya oil
Solvesso ® 200 ND: Naphthalene-free mixture of aromatics, boiling point >120° C.

TABLE 2
Oil phases

| | | Example No. | | | | | | |
|---|---|---|---|---|---|---|---|---|
| Components | | 1 | 2 | 3 | 4 | 5 | 6 | 7 |
| b1 | Fenoxaprop-P | 8.15 | | | 5.75 | 6.5 | | |
| b1 | Active substance A (dispersed) | 3.24 | 3.24 | 3.24 | 4.4 | 4.4 | 8 | 3.3 |
| b1 | Mefenpyr (safener) | 3.06 | 0.84 | 0.84 | 2.2 | 1.4 | 2.5 | 0.9 |
| b1 | Bromoxynil octanoate | 17.8 | 17.8 | 17.8 | 17 | | | 20 |
| b2 | Soprophor ® 4D384 | 2 | 2 | | 2 | 3 | 3 | 2 |
| b2 | Soprophor ® 3 D33 | | | 2 | | | | |
| b2 | Calsogen ® AR 100 ND | 3 | 3 | | 3 | 4 | 3 | 3.5 |
| b2 | Genapol ® X 150 | 4 | 4 | | 4 | 5 | 4 | 5.5 |
| b2 | Genapol ® X 060 | | | 6.5 | | | | |
| b2 | Soprophor ® CY/8 | 3 | 3 | 3 | 3 | 3 | 3 | 3 |
| b2 | Soprophor ® BSU | | | 2 | | | | |
| b3 | Rapeseed oil, refined | 2.5 | 2.5 | 2.5 | 3 | 21 | 25 | 10 |
| b4 | Bentone ® SD1 | 2 | 2 | 1 | 1 | 1.8 | 2 | 1.1 |
| b5 | Edenol ® D 81 | 2 | 2 | 2 | 3 | 3 | 2 | 1.2 |
| b3 | Solvesso ® 200 ND | to 100 | to 100 | to 100 | to 100 | to 100 | to 100 | to 100 |

All data in % by weight
Active substance A: (5-hydroxy-1,3-dimethyl-1H-pyrazol-4-yl)[2-(methylsulfonyl)-4-(trifluoromethyl)phenyl]methanone
Soprophor ® 4D384: Ethoxylated + sulfated tristyrylphenol
Soprophor ® 3 D33: Ethoxylated + phosphated tristyrylphenol
Calsogen ® AR 100 ND: CaDBS in Solvesso ND
Genapol ® X 150: Isotridecyl alcohol with 15 EO
Genapol ® X 060: Isotridecyl alcohol with 6 EO
Soprophor ® CY/8: Tristyrylphenol with 20 EO
Soprophor ® BSU: Tristyrylphenol with 16 EO
Bentone ® SD1: Layer - structured alumosilicate
Edenol ® D 81: Epoxidized soya oil
Solvesso ® 200 ND: Naphthalene-free mixture of aromatics, boiling point >120° C.

1. A water-in-oil suspoemulsion comprising
(a) a water phase and
(b) an oil phase comprising:
(b1) at least one agrochemical active substance,
(b2) at least one surfactant selected from the group consisting of alkoxylated tristyryl phenols, calcium dodecylbenzenesulfonate and linear and/or branched alkoxylated C₁-C₂₂-alcohols,
(b3) at least one organic carrier media,
(b4) at least one thickener selected from the group consisting of modified natural silicates and synthetic silicates, and on the basis of synthetic polymers, natural polymers and natural oils.

2. The water-in-oil suspoemulsion as claimed in claim 1, wherein the water phase (a) comprises:
(a1) at least one ionic surfactant selected from the group consisting of polycarboxylates, N-alkyl-taurides, lignosulfonates and calcium dodecylbenzenesulfonates,
(a2) at least one or more salt,
(a3) optionally, at least one agrochemical active substance.

3. The water-in-oil suspoemulsion as claimed in claim 1, which comprises at least two active substances, at least one of which is present in dispersed form.

4. The water-in-oil suspoemulsion as claimed in claim 1, further comprising in the water phase (a) at least one further surfactant (component (a4)), which differs from component (a1).

5. The water-in-oil suspoemulsion as claimed in claim 1, further comprising in the water phase (a) at least one customary auxiliary and/or additive (component (a5)).

6. The water-in-oil suspoemulsion as claimed in claim 1, further comprising, in the oil phase (b), at least one further adjuvant(component (b5)).

7. The water-in-oil suspoemulsion as claimed in claim 1, wherein at least one water-soluble active substance and/or active substance which is insoluble in water, and which is dispersible in the water phase (a), is present as component (a3).

8. The water-in-oil suspoemulsion as claimed in claim 2, wherein said agrochemical active substance of (a3) and/or (b1) is selected from the group of herbicides, salts of phenylacetic, phenylpropionic, phenylbutyric or isobutyric acid derivatives, including optically active forms; salts of bromoxynil derivatives or ioxynil derivatives, phenylureas, diuron, IPU, linuron; beet herbicides, phenmedipham, desmedipham, ethofumesate, metamitron; (5-hydroxy-1,3-dimethyl-1H-pyrazol-4-yl)[2-(methylsulfonyl)-4-(trifluoromethyl)phenyl]methanone, N-[(1 R,2S)-2,6-dimethyl-2,3-dihydro- 1H-inden- 1-yl]-6-[(1R)- 1-fluoroethyl]-1,3,5-triazine-2,4-diamine, including their optically active alternatives, fluratom, and flufenacet.

9. A process for the preparation of a water-in-oil suspoemulsion according to claim 1, comprising mixing said water phase and said oil phase with one another.

10. A preparation, obtainable by dilution of a water-in-oil suspoemulsion as claimed claim 1 with a further fluid.

11. A process for preparing a preparation, comprising diluting in the water-in-oil suspoemulsion as claimed in claim 1 with a fluid.

12. A method for controlling undesired vegetation comprising utilizing a water-in-oil suspoemulsion according to claim 1.

13. A method of controlling undesired vegetation, comprising applying a water-in-oil suspoemulsion as claimed in claim 1 to harmful plants, plant parts, plant seeds and/or an area where plants grow.

14. An oil phase (b), comprising:
(b1) at least one agrochemical active substance,
(b2) at least one surfactant selected from the group consisting of alkoxylated tristyryl phenols, calcium dodecylbenzenesulfonate and linear and/or branched alkoxylated C₁-C₂₂-alcohols
(b3) at least one organic carrier media,
(b4) at least one thickener selected from the group consisting of modified natural silicates and synthetic silicates, and on the basis of synthetic polymers, natural polymers and natural oils.

15. A method of preparing an oil phase (b), of claim 14 comprising combining components (b1), (b2), (b3), (b4) and mixing said components with one another.

16. A preparation obtainable from an oil phase (b) according to claim 14, and a further fluid.

17. A process for preparing a preparation comprising mixing the oil phase (b) according to claim 14 with a fluid.

18. A method for controlling unwanted vegetation comprising utilizing an oil phase (b) according to claim 14.

19. A method of controlling undesired vegetation, which comprises applying an oil phase (b) according to claim 14 to harmful plants, plant parts, plant seeds and/or an area where plants grow.

20. A method for the preparation of ready-to-use formulations of active substances which are employed in the veterinary medicine sector comprising utilizing an oil phase as claimed in claim 14.
